(19) United States
(12) Patent Application Publication
(10) Pub. No.: US 2019/0184319 A1
(43) Pub. Date: Jun. 20, 2019

(54) FLUID PROCESSING DEVICE AND PROCESSING LIQUID RECOVERY METHOD

(71) Applicant: Shimadzu Corporation, Kyoto (JP)

(72) Inventors: Katsuhiro TANAKA, Kyoto (JP); Yosuke IWATA, Kyoto (JP)

(21) Appl. No.: 16/323,014

(22) PCT Filed: Jun. 30, 2017
(86) PCT No.: PCT/JP2017/024088

§ 371 Date: Feb. 4, 2019

(30) Foreign Application Priority Data
Aug. 3, 2016 (JP) 2016-152855

(51) Int. Cl. B01D 45/00; F25B 43/00

(52) U.S. Cl. CPC B01D 45/00; B65G 53/60; F25B 43/00

(57) ABSTRACT

A fluid processing system includes: a fluid processing section that performs a treatment of a sample while flowing fluid through a channel, the fluid after passage through the fluid processing section including gas and liquid; a gas-liquid separation section that is connected to an outlet side of the back pressure valve, that includes a gas-liquid separation pipe made of material letting the gas through and not letting the liquid through, and that discharges a gas phase in the fluid flowing through the gas-liquid separation pipe to an outside of the gas-liquid separation pipe; and a liquid phase collecting section that is provided on a downstream of the gas-liquid separation section and that recovers the liquid after passage through the gas-liquid separation section.

### TECHNICAL FIELD

The present invention relates to a fluid processing system including a super-critical fluid system that performs separation or extraction of a sample component by using a super-critical fluid, a flow synthesis system that performs flow synthesis, which is synthesis of a predetermined compound, by flowing a liquid including a raw material through at least one column to thereby cause a reaction, and relates to a processed liquid collecting method for collecting the liquid having gone through the process in the fluid processing system as a processed liquid.

### BACKGROUND ART

In a super-critical fluid chromatograph (SFC) or a super-critical fluid extraction (SFE) system, for example, a mixed fluid of carbon dioxide and modifier is delivered as a mobile phase through an analytical channel. A back pressure valve for regulating a pressure in the analytical channel is provided to the analytical channel and regulates the pressure in the analytical channel so that the pressure becomes higher than or equal to 10 MPa (megapascals). In the analytical channel, carbon dioxide in the mobile phase flows in a super-critical fluid state or a liquid state. On a downstream of the back pressure valve, the pressure in the channel is normally at an atmospheric pressure. Therefore, a pressure of carbon dioxide after passing through the back pressure valve is reduced to the atmospheric pressure and carbon dioxide is vaporized.

In the SFC or the SFE system with a preparative function, a sample dissolved in the mixed fluid of carbon dioxide and the modifier is collected after passage through the back pressure valve. Because carbon dioxide increases 400-fold in volume when vaporized, the modifier is aerosolized in carbon dioxide, which is at a high linear velocity, and ejected from a pipe outlet with vaporized carbon dioxide. As a result, the modifier including the sample component is scattered and part of the sample component is lost.

To solve the problem, in general, a gas-liquid separator for separating fluid after passing through a back pressure valve into a gas phase (carbon dioxide) and a liquid phase (modifier which is mainly methanol) by spirally flowing the fluid along an edge of a container is provided (see Patent Documents 1, 2). The liquid phase separated from the gas phase by the gas-liquid separator is collected into a predetermined container.

### PRIOR ART DOCUMENTS

### Patent Documents

Patent Document 1: Japanese Patent Application Laid-open National Publication No. 2009-544042

Patent Document 2: Japanese Patent Application Laid-open Publication No. 2010-78532

Patent Document 3: Japanese Patent Application Laid-open Publication No. 2015-172025

### SUMMARY OF THE INVENTION

### Problems to be Solved by the Invention

Even if the above-described gas-liquid separator is provided, the liquid phase is ejected from the pipe outlet with vaporized carbon dioxide. Therefore, the liquid phase is scattered by carbon dioxide to thereby cause reduction in collection rate and contamination of multiple analysis components. Moreover, if the gas-liquid separator is provided on an upstream of a collecting container, the liquid phase ejected from the pipe outlet is likely to remain in the gas-liquid separator and the remaining liquid phase can cause the contamination and, as a result, it is necessary to clean the gas-liquid separator for each analysis. Therefore, a structure for easily performing the gas-liquid separation without ejecting the fluid is desired.

In a field of flow synthesis for forming useful molecules such as a pharmaceutical drug by flowing row material into a column in stages while causing a reaction, a process for removing a gas phase, included in liquid including a product, and collecting only a liquid phase may be performed in some cases (see Patent Document 3). In this case, a structure with which the gas phase can be easily removed from fluid in a flow of process for the flow synthesis is preferable.

Therefore, it is an object of the present invention to easily collect a liquid phase while removing a gas phase from fluid including the gas phase and the liquid phase after going through a predetermined process in fields of analysis and extraction by use of super-critical fluid, flow synthesis, and the like.

### Solutions to the Problems

According to an aspect of the present invention, a fluid processing system is provided including:

a fluid processing section that performs a process for analysis or extraction of a component or synthesis while flowing fluid through a channel, the fluid which flows out from the fluid processing section includes a gas phase and a liquid phase;

a gas-liquid separation section connected to a downstream of the fluid processing section, the gas-liquid separation section comprises a gas-liquid separation pipe formed by material which allows gas through and does not allow liquid through, and the liquid phase from the gas phase is separated by discharging the gas phase in the fluid flowing through the gas-liquid separation pipe to an outside of the gas-liquid separation pipe through a wall face of the gas-liquid separation pipe; and

a liquid phase collecting section provided on a downstream of the gas-liquid separation section and collects the liquid phase separated from the gas phase in the gas-liquid separation section.

The fluid processing system according to the aspect of the invention may be a super-critical fluid system that performs separation or extraction of a sample component by using super-critical fluid. In this case, the fluid processing section includes a mobile phase delivery channel through which mixed fluid of carbon dioxide and modifier is delivered as a mobile phase and a back pressure valve that regulates a pressure in the mobile phase delivery channel so as to keep the mobile phase in a super-critical state in the mobile phase delivery channel.

The fluid processing system according to the aspect of the invention may be a flow synthesis system for performing flow synthesis which is synthesis of a predetermined compound by flowing liquid including a raw material through at least one column to thereby cause a reaction.

The gas-liquid separation section may include a pressurization section that maintains an inside of the gas-liquid separation pipe at a pressure higher than an atmospheric pressure. In this way, it is possible to more efficiently discharge the gas phase in the fluid flowing through the gas-liquid separation pipe to the outside of the gas-liquid separation pipe.

As a structure embodying the pressurization section, a channel segment having a smaller inside diameter than the gas-liquid separation pipe may be provided to a downstream end downstream end of the gas-liquid separation pipe or on a downstream of the downstream end of the gas-liquid separation pipe. This structure simplifies a structure of the gas-liquid separation section and reduces cost.

As another structure embodying the pressurization section, a pressure regulating valve, that regulates a pressure in the gas-liquid separation pipe so that the pressure becomes a predetermined pressure higher than the atmospheric pressure, may be provided on a downstream of the gas-liquid separation pipe. With the pressure regulating valve, it is possible to reliably obtain the pressure necessary for discharging the gas phase in the fluid flowing through the gas-liquid separation pipe from the gas-liquid separation pipe to thereby more reliably realize the gas-liquid separation in the gas-liquid separation section.

The gas-liquid separation section may include a pressure reducing mechanism that reduces a pressure around the gas-liquid separation pipe to a pressure lower than a pressure in the gas-liquid separation pipe. The pressure reducing mechanism may be provided instead of or in addition to the pressurization section. It is possible to facilitate the discharge of the gas phase in the fluid flowing through the gas-liquid separation pipe from the gas-liquid separation pipe not only by increasing the pressure in the gas-liquid separation pipe but also by reducing the pressure around the gas-liquid separation pipe.

An example of the material of the gas-liquid separation pipe is polytetrafluoroethylene.

According to another an aspect of the invention, a processed liquid collecting method is provided including the steps of: introducing fluid, including a gas phase and a liquid phase and after passage through a fluid processing section, into a gas-liquid separation pipe made of material which allows gas through and does not allow liquid through, the fluid processing section performing a treatment of a sample while flowing the fluid through a channel; separating the liquid phase from the gas phase by discharging the gas phase included in the fluid flowing through the gas-liquid separation pipe to an outside of the gas-liquid separation pipe through a wall face of the gas-liquid separation pipe; and recovering the liquid phase separated from the gas phase through the gas-liquid separation pipe as processed liquid.

### Effects of the Invention

The fluid processing system according to the aspect of the invention is provided, on the downstream of the fluid processing section that performs the treatment of the sample while flowing the fluid through the channel, with the gas-liquid separation section that includes the gas-liquid separation pipe made of the material letting the gas through and not letting the liquid through, and that separates the gas phase in the fluid flowing through the gas-liquid separation pipe from the liquid phase by discharging the gas phase to the outside of the gas-liquid separation pipe through the wall face of the gas-liquid separation pipe. Therefore, it is possible to easily remove the gas phase from the fluid after passage through the fluid processing section. In this way, it is possible to easily and highly efficiently recover the liquid phase in the fluid after the passage through the fluid processing section. Moreover, a gas-liquid separator used in the prior art is unnecessary, which simplifies the structure and avoids scattering of the liquid phase from the pipe outlet. Therefore, the scattered liquid does not remain in the gas-liquid separator, and the gas-liquid separator does not need cleaning for every analysis unlike in the case of the prior-art gas-liquid separator.

The processed liquid collecting method according to the aspect of the invention removes the gas phase while flowing the fluid after passage through the fluid processing section through the channel and recovers the liquid phase separated from the gas phase as the processed liquid. Therefore, it is possible to easily and highly efficiently recover the liquid phase in the fluid after the passage through the fluid processing section.

### BRIEF DESCRIPTION OF THE DRAWINGS

FIG. 1 is a channel structure diagram schematically showing an embodiment of a super-critical fluid chromatograph.

FIG. 2 is a structure diagram schematically showing an example of a structure of a gas-liquid separator.

FIG. 3 is a structure diagram schematically showing another example of the structure of the gas-liquid separator.

FIG. 4 is a structure diagram schematically showing yet another example of the structure of the gas-liquid separator.

### EMBODIMENT OF THE INVENTION

An embodiment of a fluid processing system according to the present invention will be described below by using the drawings.

An embodiment of a super-critical fluid system which is one of the fluid processing systems is shown in FIG. 1.

The super-critical fluid system according to the embodiment includes a fluid processing section 1 for performing an analytical process of components while flowing fluid through a channel, a gas-liquid separation section 24, and a liquid phase collecting section 27. The fluid processing section 1 includes a mobile phase delivery channel 2, a sample injection section 14, an analytical column 16, a detector 20, and a back pressure valve 22. The sample injection section 14, the analytical column 16, and the detector 20 are provided on the mobile phase delivery channel 2 in this order from an upstream. The back pressure valve 22 is connected to a downstream end of the mobile phase delivery channel 2.

The gas-liquid separation section 24 is provided on a downstream of the back pressure valve 22 and the liquid phase collecting section 27 is provided on a downstream of the gas-liquid separation section 24. The liquid phase collecting section 27 includes a channel switching valve 28 connected to the downstream of the gas-liquid separation section 24 and a plurality of collecting containers 30a to 30d connected to respective ports of the channel switching valve 28. Although the four collecting containers 30a to 30d are shown in the embodiment, any number of collecting containers may be provided.

On an upstream of the mobile phase delivery channel 2, delivery pumps 8, 10 for respectively delivering carbon dioxide and modifier in liquid states and a mixer 12 for mixing the carbon dioxide and the modifier are provided. Carbon dioxide delivered from a carbon dioxide cylinder 4 by the delivery pump 8 and the modifier delivered from a modifier container 6 by the delivery pump 10 are mixed by the mixer 12 to become mixed fluid and flows through the mobile phase delivery channel 2 as a mobile phase.

The back pressure valve 22 is controlled so that a pressure in the mobile phase delivery channel 2 becomes a predetermined pressure (e.g., 10 MPa). In this way, carbon dioxide in the mobile phase flows in a super-critical state through the mobile phase delivery channel 2.

A sample to be analyzed is introduced into the mobile phase delivery channel 2 by the sample injection section 14. The analytical column 16 is connected to a downstream of the sample injection section 14 and the sample introduced into the mobile phase delivery channel 2 via the sample injection section 14 is separated into the components in the analytical column 16. The analytical column 16 is housed in a column oven 18 and a temperature of the analytical column 16 is kept constant. The detector 20 is connected to a downstream of the analytical column 16 and the sample components eluted from the analytical column 16 are consecutively introduced into the detector 20.

The back pressure valve 22 is connected to a downstream of the detector 20 and the gas-liquid separation section 24 is provided on an outlet side of the back pressure valve 22. The gas-liquid separation section 24 includes a gas-liquid separation pipe 26. The gas-liquid separation pipe 26 is a pipe formed by material which allows gas through and does not allow liquid through. An example of the material of the gas-liquid separation pipe is PTFE (polytetrafluoroethylene). The gas-liquid separation section 24 separates the fluid flowing out of the outlet of the back pressure valve 22 into the gas phase and the liquid phase by utilizing the gas-liquid separation pipe 26.

Carbon dioxide in the fluid flowing out of the outlet of the back pressure valve 22 is vaporized to be the gas phase due to rapid reduction in pressure. On the other hand, the modifier is in the liquid state before and after the back pressure valve 22. Almost entire quantities of the sample components eluted from the analytical column 16 are dissolved in the modifier which is the liquid phase. The gas-liquid separation section 24 is formed to discharge carbon dioxide, which is the gas phase in the fluid flowing through the gas-liquid separation pipe 26, to an outside of the gas-liquid separation pipe 26 and to lead only the liquid phase to the channel switching valve 28 provided on the downstream.

The channel switching valve 28 of the liquid phase collecting section 27 is a rotary switching valve, for example, and connects a channel from the gas-liquid separation section 24 to one of the collecting containers 30a to 30d. The channel switching valve 28 switches the channel in synchronization with a detection signal from the detector 20. and the liquid phases including the respective sample components separated in the analytical column 16 are collected in the separate collecting containers 30a to 30d.

In the super-critical fluid system according to the embodiment, the gas phase is discharged to the outside of the channel in the gas-liquid separation section 24, and therefore, only the liquid phases are dropped into the respective collecting containers 30a to 30d. Thus, vaporized carbon dioxide is not ejected from an outlet of the pipe communicating with the collecting containers 30a to 30d and the liquid phases are not scattered.

It is possible to enhance efficiency of the gas-liquid separation section 24 in separating the fluid into the gas and the liquid by providing a pressurization section for increasing a pressure in the gas-liquid separation pipe 26.

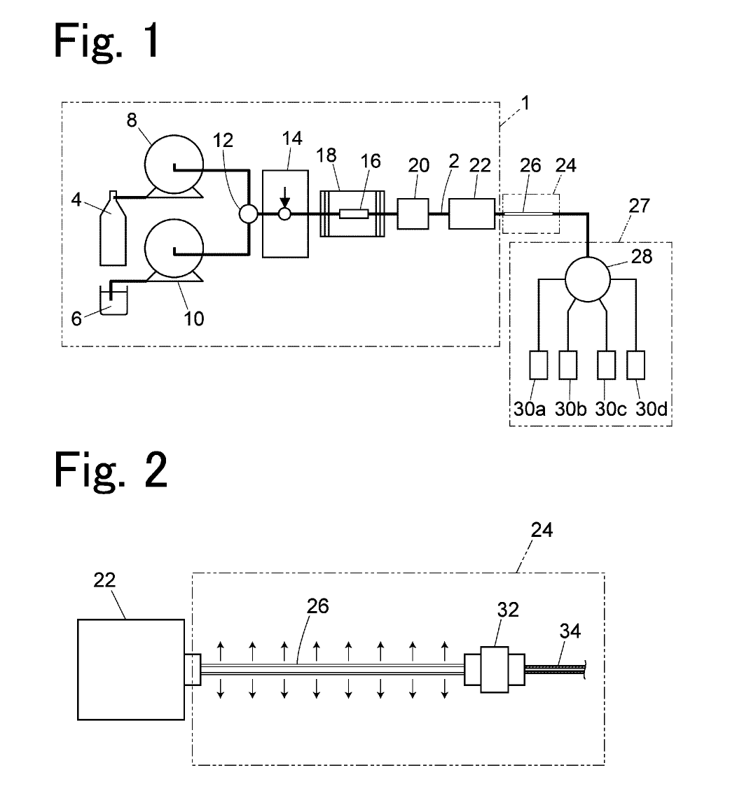

An example of the gas-liquid separation section 24 provided with the pressurization section is shown in FIG. 2.

In a structure in FIG. 2, a tubing 34 as the pressurization section is connected by a joint 32 to a downstream of the gas-liquid separation pipe 26. The tubing 34 has a smaller inside diameter than the gas-liquid separation pipe 26 and maintains an inside of the gas-liquid separation pipe 26 at a pressure (e.g., 3 MPa) higher than an atmospheric pressure. Because the pressure in the gas-liquid separation pipe 26 is maintained at the pressure higher than the atmospheric pressure, discharge of the gas phase in the fluid flowing through the gas-liquid separation pipe 26 to the outside of the gas-liquid separation pipe 26 is facilitated and the efficiency in separating the fluid flowing out of the outlet of the back pressure valve 22 into the gas and the liquid is enhanced.

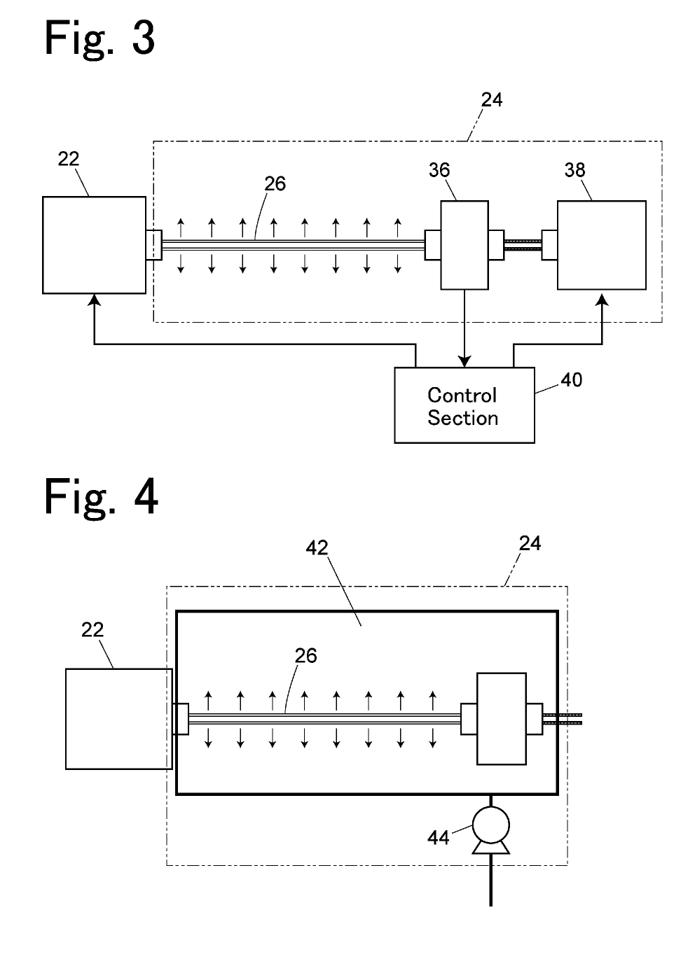

Another example of the structure of the gas-liquid separation section 24 provided with the pressurization section is shown in FIG. 3.

In a structure in FIG. 3, a pressure sensor 36 is provided on a downstream of a gas-liquid separation pipe 26 and a pressure control valve 38 as the pressurization section is provided on a downstream of the pressure sensor 36. The pressure control valve 38 has a similar structure to the back pressure valve 22, for example. Operation of the pressure control valve 38 is controlled by a control section 40. The control section 40 controls the operation of the pressure control valve 38 based on a detection signal from the pressure sensor 36 so that a pressure in the gas-liquid separation pipe 26 becomes a pressure (e.g., 3 MPa) higher than an atmospheric pressure. The control section 40 may be used also as a control section for controlling operation of the back pressure valve 22, for example, as shown in FIG. 3.

With the structure in FIG. 3, as with the structure in FIG. 2, discharge of a gas phase in fluid flowing through the gas-liquid separation pipe 26 to an outside of the gas-liquid separation pipe 26 is facilitated, and efficiency in separating the fluid flowing out of an outlet of the back pressure valve 22 into gas and liquid is enhanced.

The pressurization section is not limited to those shown in FIGS. 2 and 3. For example, the pressure section may be any structure such as a structure including an orifice section having a smaller inside diameter than the gas-liquid separation pipe 26 and provided to a downstream end of the gas-liquid separation pipe 26 or on a downstream of the downstream end of the gas-liquid separation pipe 26, if the structure can maintain an inside of the gas-liquid separation pipe 26 at a pressure higher than an atmospheric pressure.

The efficiency of the gas-liquid separation section 24 in separating the fluid into the gas and the liquid is enhanced also by providing a pressure reducing section for reducing a pressure outside the gas-liquid separation pipe 26 instead of or in addition to the pressurization section.

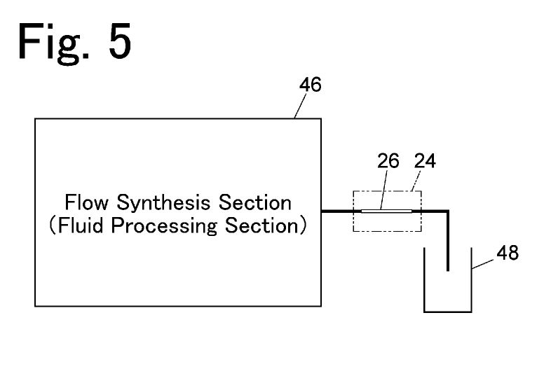

An example of a structure of the gas-liquid separation section 24 provided with the pressure reducing section is shown in FIG. 4.

In a gas-liquid separation section 24 in this example, a gas-liquid separation pipe 26 is housed in a closed space 42. An inside of the closed space 42 is reduced in pressure to a pressure lower than an atmospheric pressure by a vacuum pump. Because the pressure in the gas-liquid separation pipe 26 is the atmospheric pressure or a pressure close to the atmospheric pressure, a pressure in the gas-liquid separation pipe 26 becomes relatively higher than the pressure around the gas-liquid separation pipe 26 when the pressure in the closed space 42 is reduced to the pressure lower than the atmospheric pressure. As a result, discharge of a gas phase in fluid flowing through the gas-liquid separation pipe 26 to an outside of the gas-liquid separation pipe 26 is facilitated, and efficiency in separating the fluid flowing out of an outlet of a back pressure valve 22 into gas and liquid is enhanced.

Although the pressure in the gas-liquid separation pipe 26 is the atmospheric pressure or the pressure close to the atmospheric pressure in the example in FIG. 4, the pressurization section shown in FIG. 2 or 3 may be used to increase the pressure in the gas-liquid separation pipe 26 to a pressure higher than the atmospheric pressure and the pressure reducing section shown in FIG. 4 may be also used to reduce the pressure outside the gas-liquid separation pipe 26 to a pressure lower than the atmospheric pressure. In this way, the discharge of the gas phase in the fluid flowing through the gas-liquid separation pipe 26 to the outside of the gas-liquid separation pipe 26 is further facilitated, and the efficiency in separating the fluid flowing out of the outlet of the back pressure valve 22 into the gas and the liquid is further enhanced.

Although the fluid flowing out of the outlet of the back pressure valve 22 is separated into the gas and the liquid by the gas-liquid separation section 24 and then only the liquid phases are introduced into the respective collecting containers 30a to 30d via the channel switching valve 28 in the super-critical fluid system described by using FIG. 1, the invention is not limited to this structure. Similar effects to those of the above-described embodiment can be obtained also by connecting a channel switching valve 28 to the downstream of the back pressure valve 22 without interposing the gas-liquid separation section 24 therebetween and providing the gas-liquid separation sections 24 between the channel switching valve 28 and the respective collecting containers 30a to 30d.

Although the super-critical fluid system described in the above embodiment is the super-critical fluid chromatograph for performing separation and analysis of the sample by using the super-critical fluid, the super-critical fluid system included in the embodiment is not limited to it. The system can be similarly applied to super-critical fluid extraction which is extraction of components included in a sample by use of super-critical fluid.

In addition to the above-described field of super-critical fluid, the invention can be similarly applied to the field of flow synthesis disclosed in Patent Document 3. In this case, as shown in FIG. 5, the above-described gas-liquid separation section 24 employing the gas-liquid separation pipe 26 can be used to remove a gas component (a gas phase) included in product liquid obtained in a final step of the flow synthesis section 46 (a fluid processing section) disclosed in Patent Document 3. A structure of the gas-liquid separation section 24 may be similar to those shown in FIGS. 2 to 4.

Although it is not shown in the figures, at least one column is provided on a channel through which liquid including raw material substances for synthesis flows in the flow synthesis section 46. A solid phase such as a catalyst which reacts with the row material substances is retained in the column. By passing the liquid including the raw material substances through the column, a reaction necessary for the synthesis occurs during the passage of the liquid. The liquid including a substance produced in the flow synthesis section 46 is introduced into the gas-liquid separation section 24 and an unnecessary gas component is removed in the gas-liquid separation section 24. The liquid phase after the removal of the unnecessary gas component in the gas-liquid separation section 24 is collected as processed liquid into a collecting container 48.

### DESCRIPTION OF REFERENCE SIGNS

1, 46: Fluid processing section
2: Mobile phase delivery channel
4: Carbon dioxide cylinder
6: Modifier container
8, 10: Delivery pump
12: Mixer
14: Sample injection section
16: Analytical column
18: Column oven
20: Detector
22: Back pressure valve
24: Gas-liquid separation section
26: Gas-liquid separation pipe
27: Liquid phase collecting section
28: Channel switching valve
30a to 30d, 48: Collecting container
32: Joint
34: Tubing
36: Pressure sensor
38: Pressure control valve
40: Control section
42: Closed space
44: Vacuum pump

1-9. (canceled)

10. A super-critical fluid system for performing separation or extraction of a sample component by using super-critical fluid comprising:
a fluid processing section which comprises a mobile phase delivery channel through which mixed fluid of carbon dioxide and modifier is delivered as a mobile phase and a back pressure valve that regulates a pressure in the mobile phase delivery channel so as to keep the mobile phase in a super-critical state in the mobile phase delivery channel, wherein the fluid which flows out from the fluid processing section is including carbon dioxide as a gas phase and modifier as a liquid phase;
a gas-liquid separation section connected to an outlet of the back pressure valve at a downstream of the fluid processing section, the gas-liquid separation section comprises a gas-liquid separation pipe formed by material which allows gas through and does not allow liquid through, wherein the carbon dioxide included in the fluid which flows out from the outlet of the back pressure valve becomes a state of gas phase, the modifier included in the fluid which flows out from the outlet of the back pressure valve maintain a state of liquid phase, and the liquid phase is separated from the gas phase by discharging the gas phase in the fluid flowing through the gas-liquid separation pipe to an outside of the gas-liquid separation pipe through a wall face of the gas-liquid separation pipe; and
a liquid phase collecting section provided on a downstream of the gas-liquid separation section and collects the liquid phase separated from the gas phase in the gas-liquid separation section.

11. The super-critical fluid system according to claim 10, wherein the gas-liquid separation section includes a pressurization section that maintains an inside of the gas-liquid separation pipe at a pressure higher than an atmospheric pressure.

12. The super-critical fluid system according to claim 11, wherein a channel segment having a smaller inside diameter than the gas-liquid separation pipe is provided as the pressurization section to a downstream end of the gas-liquid separation pipe or on a downstream of the downstream end of the gas-liquid separation pipe.

13. The super-critical fluid system according to claim 11, wherein a pressure regulating valve, that regulates a pressure in the gas-liquid separation pipe so that the pressure becomes a predetermined pressure higher than the atmospheric pressure, is provided as the pressurization section on a downstream of the gas-liquid separation pipe.

14. The super-critical fluid system according to claim 10, wherein the gas-liquid separation section includes a pressure reducing mechanism that reduces a pressure around the gas-liquid separation pipe to a pressure lower than a pressure in the gas-liquid separation pipe.

15. The super-critical fluid system according to claim 10, wherein the gas-liquid separation pipe is made of polytetrafluoroethylene.
